(19) United States
(12) Patent Application Publication
(10) Pub. No.: US 2017/0021726 A1
(43) Pub. Date: Jan. 26, 2017

(54) HYDROGEN FUEL CHARGING DISPLAY SYSTEM AND CHARGING DISPLAY METHOD THEREOF

(71) Applicant: Hyundai Motor Company, Seoul (KR)

(72) Inventor: Sang Pil Kim, Gwangmyeong (KR)

(21) Appl. No.: 14/963,503

(22) Filed: Dec. 9, 2015

(30) Foreign Application Priority Data
Jul. 22, 2015 (KR) 10-2015-0103534

(51) Int. Cl. B60K 37/02; H01M 8/04082

(52) U.S. Cl. CPC B60K 37/02; H01M 8/04201; H01M 2250/20; B60K 2350/1076

(57) ABSTRACT

A charging state display system includes: a hydrogen fuel tank controller of the vehicle calculating a maximum chargeable hydrogen fuel amount from a charging pressure of a hydrogen station when hydrogen is charged into the vehicle; a hydrogen fuel supply controller providing pressure information of the hydrogen station to the hydrogen fuel tank controller; a fuel charging interface unit transmitting information between the hydrogen fuel tank controller and the hydrogen fuel supply controller via infrared (IR) communication; and a cluster having a display unit which displays information calculated from the hydrogen fuel tank controller.

### CROSS-REFERENCE TO RELATED APPLICATION

This application claims under 35 U.S.C. §119(a) the benefit of and priority to Korean Patent Application No. 10-2015-0103534 filed on Jul. 22, 2015, the entire contents of which being incorporated herein by reference.

### BACKGROUND

(a) Technical Field

The present disclosure relates generally to a charging state display system of a hydrogen fuel vehicle. More particularly, the present disclosure relates to an improved charging state display system of a hydrogen fuel vehicle which is provided with hydrogen charging pressure information of a hydrogen station to calculate a charged hydrogen fuel amount to be displayed on a fuel gauge.

(b) Background Art

Generally, external electric energy is used charged to an electric vehicle, while a hydrogen fuel vehicle directly generates electric energy to drive a motor. In the hydrogen fuel vehicle, hydrogen in a hydrogen storage tank is supplied to a fuel cell, the hydrogen is decomposed into a hydrogen proton and electron by an electrolyte in the fuel cell, the hydrogen proton reacts with oxygen to generate water and heat, and the electron is used as electric energy which drives a motor. Advantageously, hydrogen fuel vehicles do not emit harmful substances. Meanwhile, fuel cell vehicles have excellent energy efficiency as compared to gasoline internal combustion engine vehicles, and thus, such vehicles have myriad advantages which are not provided by the typical gasoline internal combustion engine vehicle.

The hydrogen of a hydrogen fuel vehicle is charged into a hydrogen tank provided in the vehicle in a hydrogen station. When low temperature hydrogen of approximately −58.15° C. is charged into the hydrogen tank of the vehicle in the hydrogen station, the temperature of hydrogen gas is sharply raised. Thus, a volume thereof expands. Due to this phenomenon, a charging pressure and a temperature of the hydrogen which is charged in the hydrogen station vary depending on hydrogen stations, such that it is difficult to obtain precise information of a maximum hydrogen fuel amount to be charged in consideration of a remaining space of the hydrogen tank, a charging pressure, and a trip distance when the tank is fully charged from the fuel gauge. Further, a user may not understand that a chargeable amount to be fully charged varies depending on different charging pressures for every hydrogen station. A user can misunderstand that the different chargeable amount is caused by a failure of a gauge of the vehicle rather than different charging pressures of the hydrogen stations.

In this regard, Japanese Unexamined Patent Application Publication No. 2003-172654 discloses a fuel display system in which when compressed natural gas (CNG) is charged at a high pressure in a station, even when a pressure in a CNG bombe is lowered due to a temperature difference between day and night, an indication value is not changed and a user is prevented from misunderstanding that it is caused by CNG leakage. Further, Japanese Unexamined Patent Application Publication No. 2005-240854 discloses a configuration in which a temperature sensor and a pressure sensor detect a temperature and a pressure of a hydrogen tank, respectively. A controller calculates a pressure type meter display value of a remaining amount in the hydrogen tank based on the pressure to calculate and display information regarding a fuel amount based on the pressure and the temperature of the fuel in the hydrogen tank. Further, Korean Unexamined Patent Application Publication No. 1999-31297 discloses a configuration which includes a fuel dispensing gun which transmits information on a refueling amount and a fuel cost transmitted from a fuel tank of a gas station where the fuel is charged in the vehicle, to the vehicle and a display unit which displays information on a contact point of the fuel dispensing gun, the refueling amount of the fuel tank which is applied from the fuel dispensing gun, and the fuel cost for a driver in the vehicle.

However, the related art, such as the publications above, merely relate to the remaining amount of the hydrogen tank in the vehicle or only display information on the fuel cost, but do not provide exact information on a maximum chargeable fuel when the fuel is charged in gas stations having different charging pressures and a trip distance depending on the maximum chargeable fuel.

The above information disclosed in this Background section is only for enhancement of understanding of the background of the disclosure, and therefore, it may contain information that does not form the prior art that is already known in this country to a person of ordinary skill in the art.

### SUMMARY OF THE DISCLOSURE

The present disclosure has been made in an effort to solve the above-described problems associated with the related art and to provide a charging state display system of a hydrogen fuel vehicle which recognizes a charging pressure through communication between a hydrogen fuel tank controller of a vehicle and a hydrogen station to provide exact information on a maximum chargeable fuel amount and a trip distance depending on the maximum chargeable fuel amount. The present disclosure has also been made in an effort to provide a charging state display method of a hydrogen fuel vehicle which displays exact information on a maximum chargeable fuel amount in the hydrogen fuel vehicle and a trip distance depending on the maximum chargeable fuel amount.

According to embodiments of the present disclosure, a charging state display system of a hydrogen fuel vehicle includes: a hydrogen fuel tank controller of the vehicle calculating a maximum chargeable hydrogen fuel amount from a charging pressure of a hydrogen station when hydrogen is charged into the vehicle; a hydrogen fuel supply controller providing pressure information of the hydrogen station to the hydrogen fuel tank controller; a fuel charging interface unit transmitting information between the hydrogen fuel tank controller and the hydrogen fuel supply controller via infrared (IR) communication; and a cluster having a display unit which displays information calculated from the hydrogen fuel tank controller.

The fuel charging interface unit may include an IR communication terminal which is provided in a hydrogen fuel dispensing gun of the hydrogen station to transmit and receive hydrogen charging information between a fuel inlet of the vehicle which is connected to the hydrogen tank of the vehicle and the hydrogen fuel dispensing gun via IR communication and an IR communication terminal which is provided in the fuel inlet of the vehicle.

The hydrogen fuel tank controller may calculate a current remaining hydrogen fuel amount in a hydrogen fuel tank of the vehicle, an available trip distance using the charged hydrogen fuel amount, and a charging pressure, based on a current pressure and temperature in the hydrogen fuel tank and a tank volume of the fuel tank of the vehicle.

The maximum chargeable hydrogen fuel amount which is charged in the hydrogen fuel tank in the vehicle from the station may be calculated by subtracting the remaining hydrogen fuel amount in a hydrogen fuel tank of the vehicle from the hydrogen fuel amount to be charged in the hydrogen fuel tank of the vehicle calculated from the charging pressure of the hydrogen fuel supplied from the hydrogen station, a current temperature in the hydrogen fuel tank in the vehicle, a tank volume of the hydrogen fuel tank, and a hydrogen pressure of the station.

The available trip distance by the maximum hydrogen fuel amount to be charged and the charging pressure may be calculated in the cluster of the vehicle.

Furthermore, according to embodiments of the present disclosure, a charging state display method of a hydrogen fuel vehicle includes: connecting a hydrogen charging cable of a hydrogen station to the vehicle; transmitting information from a hydrogen fuel supply controller of the hydrogen station and a fuel tank controller of the vehicle via IR communication; calculating a maximum hydrogen fuel amount to be charged in a hydrogen fuel tank of the vehicle based on the information from a hydrogen fuel supply controller; transmitting the hydrogen fuel charging information to a cluster in the vehicle; and displaying the transmitted hydrogen fuel charging information by the cluster.

The displayed hydrogen fuel charging information may include a current charged amount, a maximum hydrogen fuel amount to be charged, an available trip distance using the hydrogen fuel amount which is fully charged, and a charging pressure.

The method may further include, after the transmitting of information from the hydrogen fuel supply controller, providing pressure information of hydrogen of the hydrogen station to a IR communication terminal of a fuel inlet of the vehicle through an IR communication terminal of the dispensing gun by the hydrogen fuel supply controller of the hydrogen station and providing transmitted pressure information of charged hydrogen to a hydrogen fuel tank controller of the vehicle by the IR communication terminal of the fuel inlet.

In the calculating of the maximum hydrogen fuel amount to be charged, the fuel tank controller of the vehicle may calculate a maximum hydrogen fuel amount to be charged from the information on a charged hydrogen pressure of the hydrogen station, a temperature of the hydrogen fuel tank of the vehicle, and a chargeable volume in the hydrogen tank excluding a remaining amount.

According to the hydrogen fuel charging state display system and the method thereof, charging information of a hydrogen station and information on a current remaining amount of a vehicle are exchanged between the hydrogen station and the vehicle so that when the hydrogen is charged in a hydrogen station where a charging pressure is low but it is displayed that the fuel is not fully charged, users' complaints may be reduced. Further, when a driver charges an exact amount of hydrogen, an additionally chargeable amount and an available trip distance are provided, thereby improving marketability and reliability.

Other aspects and embodiments of the disclosure are discussed infra.

### BRIEF DESCRIPTION OF THE DRAWINGS

The above and other features of the present disclosure will now be described in detail with reference to certain embodiments thereof illustrated in the accompanying drawings which are given hereinbelow by way of illustration only, and thus are not limitative of the present disclosure, and wherein:

FIG. 1 is a schematic diagram of a hydrogen fuel charging state display system of the present disclosure;

FIG. 2 is a flowchart of a charging state display method of FIG. 1; and

FIG. 3 is an exemplary view of a display unit of FIG. 1 in which a hydrogen fuel charging state is displayed.

Reference numerals set forth in the Drawings includes reference to the following elements as further discussed below:

```
  1: hydrogen fuel tank controller
  2: hydrogen fuel supply controller
10: fuel charging interface unit
15: dispensing gun
16: IR communication terminal of a fuel inlet
17: Fuel inlet
18: IR communication terminal of a dispensing gun
20: display unit
```

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION OF THE EMBODIMENTS

Hereinafter, reference will now be made in detail to various embodiments of the present disclosure, examples of which are illustrated in the accompanying drawings and described below. While the disclosure will be described in conjunction with embodiments, it will be understood that present description is not intended to limit the disclosure to those exemplary embodiments. On the contrary, the disclosure is intended to cover not only the embodiments, but also various alternatives, modifications, equivalents and other embodiments, which may be included within the spirit and scope of the disclosure as defined by the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Hereinafter, the present disclosure will be described in detail with reference to accompanying drawings which illustrate embodiments of the present disclosure.

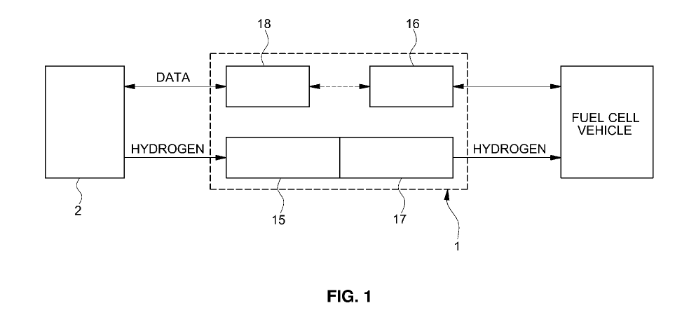

A charging state display system of a hydrogen fuel vehicle according to embodiments of the present disclosure which is schematically illustrated in FIG. 1 includes a hydrogen fuel tank controller 1 of a vehicle when a hydrogen fuel vehicle is charged with hydrogen, a hydrogen fuel supply controller 2 of a hydrogen station, a fuel charging interface unit 10 which receives information between the controllers through infrared (IR) communication, and a display unit 20 which displays a remaining hydrogen fuel amount in the current hydrogen fuel tank, a maximum hydrogen fuel amount to be charged, a charging pressure, and an available trip distance when the tank is fully charged.

The fuel charging interface unit 10 transmits and receives hydrogen charging state information through bidirectional IR communication between a fuel inlet which is connected to a hydrogen tank (which is not illustrated) of the hydrogen fuel vehicle and a hydrogen fuel dispensing gun of the hydrogen station. It is also understood that communication methods other than the above-mentioned IR communication may be used.

To this end, the interface unit 10 includes an IR communication terminal 18 which is provided in the dispensing gun 15 of the hydrogen station and an IR communication terminal 16 which is provided in a fuel inlet 17 of the vehicle.

The dispensing gun 15 of the hydrogen station provides pressure information of hydrogen to be charged to the IR communication terminal 16 of the fuel inlet of the vehicle through the IR communication terminal 18 and the IR communication terminal 16 provides transmitted pressure information of charged hydrogen to a hydrogen fuel tank controller 1 of the vehicle. Further, in the hydrogen fuel tank of the vehicle, information of a temperature and a pressure is provided to the hydrogen fuel tank controller 1 of the vehicle by a temperature sensor and a pressure sensor which are not illustrated in the drawing. Controller area network (CAN) communication is used as communication among the temperature sensor, the pressure sensor in the vehicle, the hydrogen fuel tank controller, and a cluster.

The hydrogen fuel tank controller 1 calculates a maximum hydrogen fuel amount to be charged in the hydrogen fuel tank based on information of a remaining amount and a temperature of the hydrogen fuel in the hydrogen fuel tank, and of a charging pressure of a hydrogen fuel to be charged, and calculates a remaining hydrogen fuel amount in the hydrogen fuel tank to transmit and display data to a display unit 20 of the cluster.

Further, an available trip distance is calculated using the hydrogen fuel amount charged in the hydrogen fuel tank to transmit and display the available trip distance to the display unit. The hydrogen fuel amount to be charged in the hydrogen fuel tank is calculated in the cluster using the information from the hydrogen fuel tank controller.

Further, the hydrogen fuel tank controller 1 transmits information on the calculated maximum hydrogen fuel amount to be charged to the IR communication terminal 18 provided in the dispensing gun 15 of the station through the IR communication terminal 16 of the fuel inlet 17 of the vehicle. The information is transmitted to the hydrogen fuel supply controller 2 of the station again and a charging amount and a cost are displayed on the display unit by comparing with information of a requested charging amount which is input by the user. The requested charging amount is displayed on the display unit within the maximum hydrogen fuel amount to be charged. When the requested charging amount is larger than the maximum hydrogen fuel amount to be charged, a correction request may be displayed.

The hydrogen fuel tank controller 1 may calculate a maximum hydrogen fuel amount to be charged using the following gas state Equation (1), based on the information of charged hydrogen pressure transmitted from the hydrogen fuel supply controller 2 of the station, the remaining hydrogen fuel amount in the hydrogen fuel tank, and information of the temperature, and the pressure received from the temperature sensor and the pressure sensor.

PV=nRT Equation (1)

Here, P is a pressure of hydrogen of the station to be charged, V is a volume of the hydrogen fuel tank of the vehicle, R is a gas constant, and T is a temperature in the hydrogen fuel tank. n is mol of hydrogen.

A mol number of hydrogen in the tank is calculated from the temperature, the pressure, and the volume of the tank in the hydrogen fuel tank of the vehicle and the weight (generally, the charged amount in the station is indicated as a weight) of hydrogen which currently remains in the tank are calculated therefrom.

Thereafter, a maximum weight of hydrogen to be charged in the tank at the pressure of the hydrogen of the station is calculated based on the pressure of hydrogen supplied from the station, the current temperature in the tank, and the volume of the tank and when the weight of the current hydrogen remaining in the tank is subtracted therefrom, the maximum charging amount to be charged from the station may be calculated. The information is calculated from the hydrogen fuel tank controller or the volume of the tank or the temperature information is transmitted to the supply controller of the station to calculate the information in the supply controller of the station. The information is transmitted to the vehicle to be displayed on the cluster.

It is easily understood that based on the hydrogen fuel amount which currently remains in the tank, an amount corresponding to the charged hydrogen fuel amount which is requested by the user among the maximum hydrogen fuel amount to be charged in the station is input so that only the hydrogen fuel amount corresponding to the input amount may be charged.

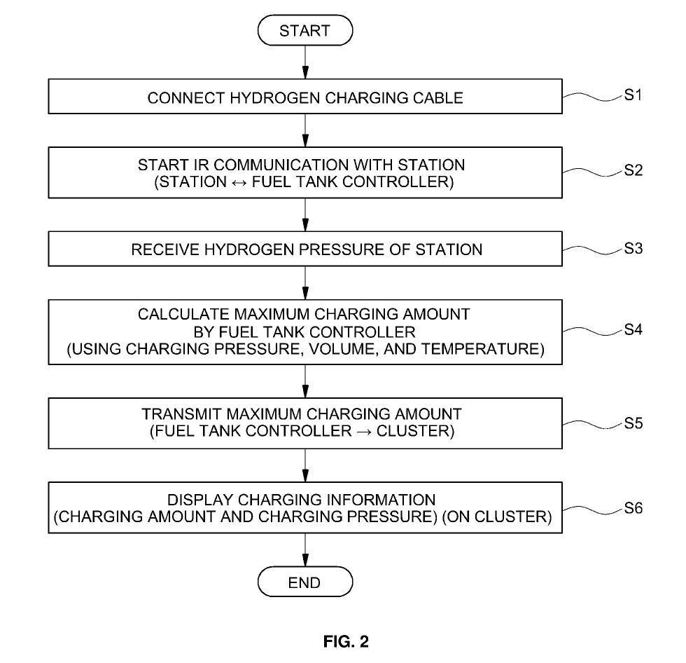

A charging state display method of a charging state display system of a hydrogen fuel vehicle according to the present disclosure will be described with reference to a flowchart illustrated in FIG. 2.

When a user connects a hydrogen charging dispensing gun of a hydrogen station to a hydrogen fuel inlet of the vehicle in step S1, a hydrogen fuel supply controller 2 of the station and a fuel tank controller 1 of a vehicle exchange information between an IR communication terminal 18 of the dispensing gun and an IR communication terminal 16 of the fuel inlet of the vehicle through the IR communication in step S2.

In this case, in step S3, the hydrogen fuel supply controller 2 of the station provides pressure information of hydrogen of the station to the IR communication terminal 16 of the fuel inlet of the vehicle through the IR communication terminal 18, and the IR communication terminal 16 provides transmitted pressure information of charged hydrogen to a hydrogen fuel tank controller 1 of the vehicle.

In step S4, the fuel tank controller 1 of the vehicle calculates a maximum chargeable hydrogen fuel amount based on information on a charged hydrogen pressure of the station, a temperature of a fuel tank of the vehicle, and a chargeable volume in the tank excluding a remaining amount.

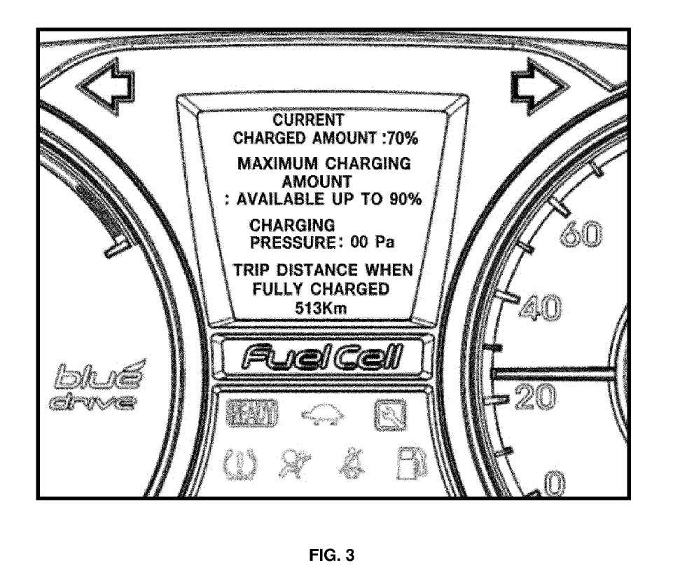

In step S5, information such as the maximum chargeable hydrogen fuel amount calculated in step S4, an available trip distance using the hydrogen fuel amount, and the charging pressure is transmitted to a display unit 20 in the vehicle and the information provided in step S5 is displayed on the display unit in step S6 and then the process ends as illustrated in FIG. 3.

Even though it is not illustrated in the flowchart, it is apparent that only the hydrogen fuel amount corresponding to an input amount corresponding to the hydrogen charging amount which is input by the user among the maximum hydrogen fuel amount to be charged in the station is charged.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

What is claimed is:

1. A charging state display system of a hydrogen fuel vehicle, comprising:
a hydrogen fuel tank controller of the vehicle calculating a maximum chargeable hydrogen fuel amount from a charging pressure of a hydrogen station when hydrogen is charged into the vehicle;
a hydrogen fuel supply controller providing pressure information of the hydrogen station to the hydrogen fuel tank controller;
a fuel charging interface unit transmitting information between the hydrogen fuel tank controller and the hydrogen fuel supply controller via infrared (IR) communication; and
a cluster having a display unit which displays information calculated from the hydrogen fuel tank controller.

2. The charging state display system of claim 1, wherein the fuel charging interface unit includes an IR communication terminal which is provided in a hydrogen fuel dispensing gun of the hydrogen station to transmit and receive hydrogen charging information between a fuel inlet of the vehicle which is connected to the hydrogen tank of the vehicle and the hydrogen fuel dispensing gun via IR communication and an IR communication terminal which is provided in the fuel inlet of the vehicle.

3. The charging state display system of claim 1, wherein the hydrogen fuel tank controller calculates a current remaining hydrogen fuel amount in a hydrogen fuel tank of the vehicle, an available trip distance using the charged hydrogen fuel amount, and a charging pressure, based on a current pressure and temperature in the hydrogen fuel tank and a tank volume of the fuel tank of the vehicle.

4. The charging state display system of claim 1, wherein the maximum chargeable hydrogen fuel amount is calculated by subtracting the remaining hydrogen fuel amount in a hydrogen fuel tank of the vehicle from the hydrogen fuel amount to be charged in the hydrogen fuel tank of the vehicle calculated from the charging pressure of the hydrogen fuel supplied from the hydrogen station, a current temperature in the hydrogen fuel tank in the vehicle, a tank volume of the hydrogen fuel tank, and a hydrogen pressure of the station.

5. The charging state display system of claim 3, wherein the available trip distance by the maximum chargeable hydrogen fuel amount and the charging pressure are calculated in the cluster of the vehicle.

6. A charging state display method of a hydrogen fuel vehicle, comprising:
connecting a hydrogen charging cable of a hydrogen station to the vehicle;
transmitting information from a hydrogen fuel supply controller of the hydrogen station and a fuel tank controller of the vehicle via IR communication;
calculating a maximum hydrogen fuel amount to be charged in a hydrogen fuel tank of the vehicle based on the information from a hydrogen fuel supply controller;
transmitting the hydrogen fuel charging information to a cluster in the vehicle; and
displaying the transmitted hydrogen fuel charging information by the cluster.

7. The charging state display method of claim 6, wherein the displayed hydrogen fuel charging information includes a current charged amount, a maximum hydrogen fuel amount to be charged, an available trip distance using the hydrogen fuel amount which is fully charged, and a charging pressure.

8. The charging state display method of claim 6, further comprising:
after the transmitting of information from the hydrogen fuel supply controller, providing pressure information of hydrogen of the hydrogen station to a IR communication terminal of a fuel inlet of the vehicle through an IR communication terminal of the dispensing gun by the hydrogen fuel supply controller of the hydrogen station and providing transmitted pressure information of charged hydrogen to a hydrogen fuel tank controller of the vehicle by the IR communication terminal of the fuel inlet.

9. The charging state display method of claim 6, wherein in the calculating of the maximum hydrogen fuel amount to be charged, the fuel tank controller of the vehicle calculates a maximum hydrogen fuel amount to be charged from the information on a charged hydrogen pressure of the hydrogen station, a temperature of the hydrogen fuel tank of the vehicle, and a chargeable volume in the hydrogen tank excluding a remaining amount.
